(19) United States
(12) Patent Application Publication
(10) Pub. No.: US 2026/0247484 A1
(43) Pub. Date: Aug. 20, 2026

(54) WIRELESS COMMUNICATION METHOD, TERMINAL DEVICE, AND NETWORK DEVICE

(71) Applicant: QUECTEL WIRELESS SOLUTIONS CO., LTD., Shanghai (CN)

(72) Inventors: Ling LYU, Frisco, TX (US); Zheng ZHAO, Shanghai (CN)

(21) Appl. No.: 19/636,176

(22) Filed: Apr. 1, 2026

Related U.S. Application Data
(63) Continuation of application No. PCT/CN2024/123480, filed on Oct. 8, 2024.

(51) Int. Cl. H04W 76/40; H04W 4/02

(52) U.S. Cl. CPC H04W 76/40; H04W 4/025

(57) ABSTRACT

A wireless communication method, a terminal device, and a network device are provided. One example method includes: receiving first information from a network device, wherein the first information indicates one or more of following: service area information, wherein the service area information indicates a service area of a first multicast and broadcast service (MBS) in a non-terrestrial network (NTN) cell; channel configuration information, wherein the channel configuration information indicates configuration information of a channel that is in the service area and carries the first MBS; or a first association relationship, wherein the first association relationship indicates an association relationship between the service area and the first MBS.

### CROSS-REFERENCE TO RELATED APPLICATIONS

This application is a continuation of International Application No. PCT/CN 2024/123480, filed on Oct. 8, 2024, the disclosure of which is hereby incorporated by reference in its entirety.

### TECHNICAL FIELD

The present application relates to the field of communications technologies, and more specifically, to a wireless communication method, a terminal device, and a network device.

### BACKGROUND

A multicast and broadcast service (MBS) may provide a multicast service and a broadcast service, and is widely used in terrestrial network (terrestrial network, TN) systems. Compared with a TN, a non-terrestrial network (non-terrestrial network, NTN) may support larger coverage. How to apply the MBS in an NTN system is a technical issue worth studying.

### SUMMARY

The present application provides a wireless communication method, a terminal device, and a network device. The following describes various aspects of the present application.

According to a first aspect, there is provided a wireless communication method. The wireless communication method includes: receiving, by a terminal device, first information transmitted by a network device, where the first information is used to indicate one or more of the following: service area information, where the service area information is used to indicate a service area of a first multicast and broadcast service MBS in a non-terrestrial network NTN cell; channel configuration information, where the channel configuration information is used to indicate configuration information of a channel that is in the service area and carries the first MBS; or a first association relationship, where the first association relationship is used to indicate an association relationship between the service area and the first MBS.

According to a second aspect, there is provided a wireless communication method. The wireless communication method includes: transmitting, by a network device, first information to a terminal device, where the first information is used to indicate one or more of the following: service area information, where the service area information is used to indicate a service area of a first multicast and broadcast service MBS in a non-terrestrial network NTN cell; channel configuration information, where the channel configuration information is used to indicate configuration information of a channel that is in the service area and carries the first MBS; or a first association relationship, where the first association relationship is used to indicate an association relationship between the service area and the first MBS.

According to a third aspect, there is provided a terminal device. The terminal device includes: a receiving unit, receiving first information transmitted by a network device, where the first information is used to indicate one or more of the following: service area information, where the service area information is used to indicate a service area of a first multicast and broadcast service MBS in a non-terrestrial network NTN cell; channel configuration information, where the channel configuration information is used to indicate configuration information of a channel that is in the service area and carries the first MBS; or a first association relationship, where the first association relationship is used to indicate an association relationship between the service area and the first MBS.

According to a fourth aspect, there is provided a network device. The network device includes: a transmitting unit, transmitting first information to a terminal device, where the first information is used to indicate one or more of the following: service area information, where the service area information is used to indicate a service area of a first multicast and broadcast service MBS in a non-terrestrial network NTN cell; channel configuration information, where the channel configuration information is used to indicate configuration information of a channel that is in the service area and carries the first MBS; or a first association relationship, where the first association relationship is used to indicate an association relationship between the service area and the first MBS.

According to a fifth aspect, there is provided a terminal device. The terminal device includes a processor, a memory, and a communications interface. The memory is configured to store one or more computer programs, and the processor is configured to invoke the computer program in the memory, to cause the terminal device to execute part or all of the steps of the method according to the first aspect.

According to a sixth aspect, there is provided a network device. The network device includes a processor, a memory, and a transceiver. The memory is configured to store one or more computer programs, and the processor is configured to invoke the computer program in the memory, to cause the network device to execute part or all of the steps of the method according to the second aspect.

According to a seventh aspect, an embodiment of the present application provides a communications system. The system includes the foregoing terminal device and/or network device. In another possible design, the system may further include another device that interacts with the terminal device or the network device in the solutions provided in embodiments of the present application.

According to an eighth aspect, an embodiment of the present application provides a computer-readable storage medium. The computer-readable storage medium stores a computer program. The computer program causes a communications device (for example, a terminal device or a network device) to execute part or all of the steps of a method according to the foregoing aspects.

According to a ninth aspect, an embodiment of the present application provides a computer program product. The computer program product includes a non-transitory computer-readable storage medium that stores a computer program. The computer program is operable to cause a communications device (for example, a terminal device or a network device) to execute part or all of the steps of a method according to the foregoing aspects. In some implementations, the computer program product may be a software installation package.

According to a tenth aspect, an embodiment of the present application provides a chip. The chip includes a memory and a processor, and the processor may invoke a computer program from the memory and run the computer program, to implement part or all of the steps of a method according to the foregoing aspects.

In embodiments of the present application, a terminal device receives first information transmitted by a network device, where the first information is used to indicate one or more of the following: service area information of a first MBS in an NTN cell; channel configuration information that is in a service area and carries the first MBS; or a first association relationship between the service area and the first MBS. The first information facilitates preventing a terminal device in an NTN system from receiving content data of the first MBS in an area other than the service area of the first MBS, thereby improving resource utilization.

### BRIEF DESCRIPTION OF THE DRAWINGS

FIG. 1 shows a wireless communications system 100 to which embodiments of the present application are applied.

FIG. 2 shows an NTN network architecture to which embodiments of the present application are applied.

FIG. 3 shows another NTN network architecture to which embodiments of the present application are applied.

FIG. 4 is a schematic flowchart of a wireless communication method according to an embodiment of the present application.

FIG. 5 is an example diagram of an association relationship between a service area and a first beam according to an embodiment of the present application.

FIG. 6 is an example diagram of a service area according to an embodiment of the present application.

FIG. 7 is a schematic diagram of a terminal device according to an embodiment of the present application.

FIG. 8 is a schematic diagram of a network device according to an embodiment of the present application.

FIG. 9 is a schematic structural diagram of a communications apparatus according to an embodiment of the present application.

### DETAILED DESCRIPTION OF THE EMBODIMENTS

Technical solutions in the present application are described below with reference to the accompanying drawings.

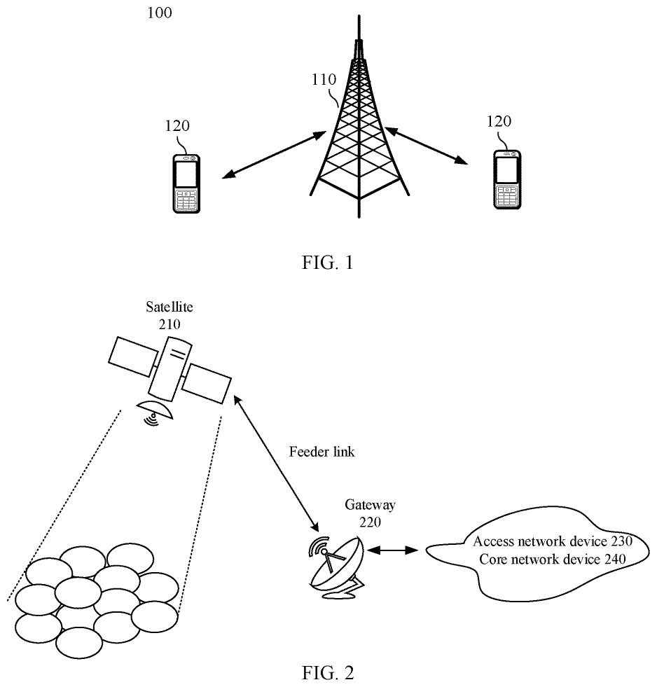

FIG. 1 shows a wireless communications system 100 to which embodiments of the present application are applied. The wireless communications system 100 may include a network device 110 and terminal devices 120. The network device 110 may be a device that communicates with the terminal device 120. The network device 110 may provide communication coverage for a specific geographical area, and may communicate with the terminal device 120 located within the coverage.

FIG. 1 illustratively shows one network device and two terminals. Optionally, the wireless communications system 100 may include a plurality of network devices, and another quantity of terminal devices may be included within coverage of each network device, which is not limited in embodiments of the present application.

Optionally, the wireless communications system 100 may further include other network entities, such as a network controller and a mobility management entity, which is not limited in embodiments of the present application.

It should be understood that technical solutions of embodiments of the present application may be applied to various communications systems, such as a 5th generation (5th generation, 5G) system or a new radio (new radio, NR) system, a long term evolution (long term evolution, LTE) system, an LTE frequency division duplex (frequency division duplex, FDD) system, and an LTE time division duplex (time division duplex, TDD) system. The technical solutions provided in the present application may further be applied to a future communications system, such as a 6th generation mobile communications system or a satellite communications system.

The terminal device in embodiments of the present application may also be referred to as user equipment (user equipment, UE), an access terminal, a subscriber unit, a subscriber station, a mobile site, a mobile station (mobile station, MS), a mobile terminal (mobile terminal, MT), a remote station, a remote terminal, a mobile device, a user terminal, a terminal, a wireless communications device, a user agent, or a user apparatus. The terminal device in embodiments of the present application may be a device providing a user with voice and/or data connectivity and capable of connecting people, objects, and machines. For example, the terminal device is a handheld device, a vehicle-mounted device, or the like having a wireless connection function. The terminal device in embodiments of the present application may be a mobile phone (mobile phone), a tablet computer (Pad), a notebook computer, a palmtop computer, a mobile Internet device (mobile internet device, MID), a wearable device, a virtual reality (virtual reality, VR) device, an augmented reality (augmented reality, AR) device, a wireless terminal in industrial control (industrial control), a wireless terminal in self driving (self driving), a wireless terminal in remote medical surgery (remote medical surgery), a wireless terminal in a smart grid (smart grid), a wireless terminal in transportation safety (transportation safety), a wireless terminal in a smart city (smart city), a wireless terminal in a smart home (smart home), or the like. Optionally, the UE may be used to function as a base station. For example, the UE may function as a scheduling entity that provides a sidelink signal between UEs in V2X, D2D, or the like. For example, a cellular phone and a vehicle communicate with each other by using a sidelink signal. A cellular phone and a smart home device communicate with each other without relaying a communication signal through a base station.

The network device in embodiments of the present application may be a device for communicating with the terminal device. The network device may also be referred to as an access network device or a radio access network device. For example, the network device may be a base station. The network device in embodiments of the present application may be a radio access network (radio access network, RAN) node (or device) that connects the terminal device to a wireless network. The base station may broadly cover various names in the following, or may be interchangeable with the following names, for example: a NodeB (NodeB), an evolved NodeB (evolved NodeB, eNB), a next generation NodeB (next generation NodeB, gNB), a relay station, an access point, a transmitting and receiving point (transmitting and receiving point, TRP), a transmitting point (transmitting point, TP), a master eNodeB MeNB, a secondary eNodeB SeNB, a multi-standard radio (MSR) node, a home base station, a network controller, an access node, a wireless node, an access point (access point, AP), a transmission node, a transceiver node, a base band unit (base band unit, BBU), a remote radio unit (Remote Radio Unit, RRU), an active antenna unit (active antenna unit, AAU), a remote radio head (remote radio head, RRH), a central unit (central unit, CU), a distributed unit (distributed unit, DU), a positioning node, or the like. The base station may be a macro base station, a micro base station, a relay node, a donor node, or the like, or a combination thereof. Alternatively, the base station may be a communications module, a modem, or a chip disposed in the device or the apparatus described above. Alternatively, the base station may be a mobile switching center, a device that functions as a base station in device-to-device D2D, vehicle-to-everything (vehicle-to-everything, V2X), or machine-to-machine (machine-to-machine, M2M) communication, a network-side device in a 6G network, a device that functions as a base station in a future communications system, or the like. The base station may support networks with a same access technology or different access technologies. A specific technology and a specific device used by the network device are not limited in embodiments of the present application.

The base station may be stationary or mobile. For example, a helicopter or an unmanned aerial vehicle may be configured to serve as a mobile base station, and one or more cells may move based on a location of the mobile base station. In other examples, a helicopter or an unmanned aerial vehicle may be configured to serve as a device in communication with another base station.

In some deployments, the network device in embodiments of the present application may be a CU or a DU, or the network device includes a CU and a DU. The gNB may further include an AAU.

The network device and the terminal device may be deployed on land, including being deployed indoors or outdoors, or being handheld or vehicle-mounted, may be deployed on a water surface, or may be deployed on a plane, a balloon, or a satellite in the air. A scenario in which the network device and the terminal device are located is not limited in embodiments of the present application.

It should be understood that all or part of functions of the communications device in the present application may also be implemented by software functions running on hardware, or by virtualization functions instantiated on a platform (for example, a cloud platform).

### NTN

With the development of communications technologies, communications systems will gradually integrate satellites and terrestrial network infrastructure, which has great market potential. According to an orbital altitude, a satellite refers to spacecraft in a low earth orbit (low earth orbit, LEO), a medium earth orbit (MEO), a geostationary earth orbit (geostationary earth orbit, GEO), or a high elliptical orbit (high elliptical orbit, HEO).

The LEO is an orbit around the earth, and has an altitude of 2,000 kilometers or less and a typical altitude ranging from 250 kilometers to 1,500 kilometers, or at least 11.25 orbits per day, with an eccentricity of less than 0.25 and an orbital period ranging from 90 minutes to 120 minutes. Most man-made objects in outer space are located in the LEO. LEO satellites orbit the earth at high speeds (mobility), but are in a predictable or definite orbit, and have characteristics such as relatively low transmission latency, small link losses, and relatively small coverage, so that the satellites are suitable for application scenarios requiring fast data transmission and low latency.

The MEO is 5,000 to 25,000 kilometers away from the earth's surface and has an orbital period ranging from 3 hours to 15 hours. An MEO satellite is a non-geosynchronous satellite, is mainly used as a supplement and extension to a land mobile communications system, and is organically combined with a ground public network to implement global personal mobile communication.

The GEO, also known as a “synchronous orbit”, is a circular orbit around the earth and at an altitude of 35,786 kilometers above the equator, and is a geostationary earth orbit. Time for a satellite in this orbit to complete one revolution around the earth is the same as time for the earth to complete one rotation (24 hours). Relative to the earth, the satellite appears stationary, so that this orbit is called a geostationary orbit.

The HEO is an elliptical orbit with a relatively low perigee and an extremely high apogee, where an altitude of the apogee is greater than that of a geostationary satellite. This orbit is usually used by spacecraft.

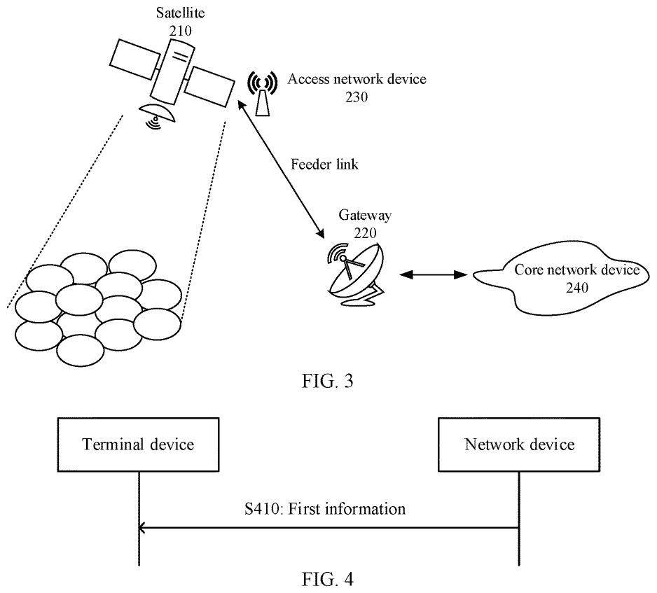

An NTN is a network or a network segment that uses a radio frequency (radio frequency, RF) resource on a satellite or an unmanned aircraft system (unmanned aircraft system, UAS) platform. In a communications standard, an NTN including a satellite segment becomes a recognized part of 3rd generation partnership project (3rd generation partnership project, 3GPP) connection infrastructure. A typical scenario of an NTN providing access to a terminal device involves an NTN transparent payload, where a satellite or UAS platform functions as a relay; or involves an NTN regenerative payload, which is provided with an access network device (for example, a gNB) thereon. Network architectures of the NTN are described below with reference to FIG. 2 and FIG. 3.

An NTN typically includes the following components:
Satellite 210: refers to a satellite of a space family platform.
Gateway 220: refers to an earth-based gateway that connects the satellite to an access network device 230 or a core network device 240, depending on selection of an architecture.

Feeder link: refers to a link between the gateway 220 and the satellite 210.

Service link: refers to a link between the satellite 210 and the terminal device.

For example, FIG. 2 and FIG. 3 respectively show two popular NTN network architectures: a bent pipe transponder architecture and a regenerative transponder architecture. In the bent pipe transponder architecture shown in FIG. 2, the access network device 230 is located on the earth behind the gateway, and the satellite 210 operates as a repeater forwarding a signal of the feeder link to the service link, and vice versa. In the regenerative transponder architecture shown in FIG. 3, the satellite 210 carries the access network device 230, and the feeder link connects the access network device to the earth-based core network device 240. In some scenarios, the access network devices of the two architectures may be base stations, for example, 4G base stations, narrow band internet of things (narrow band internet of things, NB-IoT) base stations, or the like.

An MBS may provide a multicast service and a broadcast service, and is widely used in TN systems. The MBS may be applied not only to live TV and live video, but also to public warning systems, for example, a system providing emergency and public safety management, or an earthquake and tsunami warning system (earthquake and tsunami warning system, ETWS), and may also be applied to services, for example, Internet of Vehicles, internet protocol version 4 (internet protocol version 4, IPv4)/internet protocol version 6 (internet protocol version 6, IPv6) multicast transmission, internet protocol television (internet protocol television, IPTV), software delivery, group communication, and Internet of Things. Compared with a terrestrial network (TN), the NTN may support a larger coverage area. How to apply an MBS in an NTN system is a technical issue worth studying.

For example, because the NTN has a capability of supporting a multi-beam layout, which enlarges a geographical coverage range of a satellite tracking area, a beam coverage range of the NTN is much greater than that of a TN, even in a low earth orbit, let alone in a geostationary earth orbit. In an example, an NR NTN may support three intended scenarios of an MBS broadcast service:

S1: An intended MBS service area is part of an NTN cell, and content of the service can be received only in the service area (for example, broadcast over a dedicated beam).

S2: An intended MBS service area is part of an NTN cell, but content of the service can be received in the entire cell.

S3: An intended MBS service area includes a list of NTN cells/tracking areas.

However, in the above three intended scenarios, whether an MBS session can directly serve one NTN cell, whether session content may be continuously received by a terminal device in one NTN cell, how to determine an intended service area of an MBS, and how to adapt broadcast configuration information to an NTN cell are all technical issues worth studying.

To resolve the foregoing problems, an embodiment of the present application provides a wireless communication method, including: receiving, by a terminal device, first information transmitted by a network device, where the first information is used to indicate one or more of the following: service area information of a first MBS in an NTN cell; channel configuration information that is in a service area and carries the first MBS; or a first association relationship between the service area and the first MBS. The first information facilitates preventing a terminal device in an NTN system from receiving content data of the first MBS in an area other than the service area of the first MBS, thereby improving resource utilization.

With reference to FIG. 4, the following describes a wireless communication method according to an embodiment of the present application. FIG. 4 is a schematic flowchart of a wireless communication method according to an embodiment of the present application. The method shown in FIG. 4 includes Step S410.

In Step S410, a network device transmits first information to a terminal device.

In some implementations, the first information is used to indicate one or more of the following: service area information, channel configuration information, or a first association relationship.

In some implementations, the service area information is used to indicate a service area of a first MBS in an NTN cell.

In some implementations, the service area may be understood as an area covered by the first MBS in the NTN cell. Accordingly, the service area information may include information for indicating the area covered by the first MBS in the NTN cell.

The NTN cell has wide coverage and may span regions or even countries. Therefore, to ensure coverage of the first MBS, in some implementations, the service area may be part or the entirety of the NTN cell, and the terminal device may receive content data of the first MBS only in the service area. For example, the network device broadcasts the content data of the first MBS by using a dedicated beam for the service area, and the terminal device in the service area may receive the content data of the first MBS.

As described above, the service area may be an area covered by the first MBS in the NTN cell. In other words, the service area is an area where the content data of the first MBS is intended to be transmitted. The service area may also be referred to as an “intended MBS service area” or an “MBS serving cell”.

In some implementations, the first MBS may be a broadcast service, that is, all terminal devices in the service area may receive the content data of the first MBS. For example, a service of the first MBS may be for an ETWS.

In some implementations, the channel configuration information is used to indicate configuration information of a channel that is in the service area and carries the first MBS.

In some implementations, the channel carrying the first MBS may be a multicast control channel (multicast control channel, MCCH) and/or a multicast traffic channel (multicast traffic channel, MTCH). Accordingly, the channel configuration information may be used to indicate configuration information of an MCCH and/or an MTCH in the service area.

In embodiments of the present application, the channel configuration information is not limited. For example, the channel configuration information is configuration information of an MCCH and/or an MTCH, and may include information such as a configuration, a repetition period, and an offset of an MCCH and/or an MTCH that carry the first MBS.

It should be noted that the information configuration information is associated with the service area, that is, the channel configuration information is configuration information related to a channel in the service area.

In some implementations, the channel carrying the first MBS is an MCCH. Since transmission/modification of the MCCH is subject to one or more session IDs of the first MBS, the terminal device is required to continuously monitor update of the channel configuration information when a session of the first MBS is started/stopped/changed or when neighboring cell information is changed.

In some implementations, the first association relationship is used to indicate an association relationship between the service area and the first MBS.

In some implementations, the first MBS has one or more service areas in the NTN cell, and the first association relationship may be used to indicate that the first MBS is associated with the one or more service areas.

When the first MBS supports transmission in a plurality of NTN cells, or in other words, when the first MBS is available in the plurality of NTN cells, the following two possible cases may be supported: one session of the first MBS may be available in the plurality of NTN cells; and one session of the first MBS is available in at least one entire NTN cell or part of at least one NTN cell.

In some implementations, if the first MBS is available in several NTN cells, the first information may not be used to indicate a service area. In other words, in each NTN cell supporting the first MBS, it is unnecessary to indicate service area information to the terminal device, because the terminal device camping on these NTN cells may receive the content data of the first MBS anywhere in the NTN cells.

In some implementations, if the first MBS is available only in part of the NTN cell, it is necessary to explicitly indicate a geographical area of the service area.

In some implementations, one service area may include one or more geographical areas, and the service area information may include geographical area information. For example, if one service area includes one or more geographical areas, the one service area is associated with one or more geographical area identities (identity, ID), and the geographical area ID may be denoted as ID_zone. Correspondingly, the geographical area information included in the service area information may be information corresponding to the one or more geographical area IDs. Based on the geographical area information, it helps the terminal device determine whether to receive or decode the session of the first MBS at a location of the terminal device, and also helps the network device transmit different sessions of the first MBS in different geographical areas.

In some implementations, the service area information includes geographical area information. In other words, the first MBS is a location-related MBS, or in other words, the first MBS is an MBS for a specific area.

In some implementations, if the service area information includes geographical area information, the terminal device may determine, based on the geographical area information, whether to initiate establishment or release of a multicast radio bearer (multicast radio bearer, MRB) corresponding to the first MBS. For example, for the first MBS broadcast service for the service area, when the terminal device is in a geographical area corresponding to the service area, the terminal device may initiate a broadcast MRB establishment procedure; and when the terminal device leaves the geographical area corresponding to the service area, the terminal device may initiate a broadcast MRB release procedure.

In some implementations, the geographical area information includes one or more of the following: a reference location, an area radius, a reference time, or geographical area associated information.

In some implementations, the geographical area information includes a reference location and an area radius. In other words, the geographical area information may be indicated by a circle. In this case, the geographical area information indicates a fixed geographical area of the service area, and is similar to a TN coverage area list. Therefore, it may also be said that the geographical area information includes TN coverage area information.

In some implementations, the geographical area information may be provided in a form of a list of reference locations and cell radii. In other words, the geographical area information includes a geographical area information list, or in other words, the geographical area information is used to indicate one or more geographical areas.

In some implementations, the geographical area information includes a reference location, an area radius, and a reference time. In this case, the geographical area information indicates a mobile geographical area of the service area.

In some implementations, if the geographical area information indicates a mobile geographical area of the service area, the reference location may be a central location of a geographical area, and a real-time central location may be derived from a satellite ephemeris corresponding to the NTN cell.

In some implementations, the geographical area associated information may be understood as other information used for indicating a geographical area. For example, the geographical area associated information indicates a polygon. The polygon may approximate a geographical area of the service area, and may match or may not match a boundary of a country or region. For another example, a geographical location of the service area is circular. However, the circular geographical location may exceed a country or region to which the first MBS belongs. The geographical area associated information may be information about an associated country or region. For another example, the terminal device may determine, by using the geographical area associated information, a temporary mobile group identity (temporary mobile group identity, TMGI) to be received; the TMGI has public land mobile network (public land mobile network, PLMN) information; and an actual geographical area of the service area may be determined based on the PLMN.

In some implementations, the service area is associated with one or more first beams. In other words, the service area includes coverage ranges of beam footprints of the one or more first beams, or in other words, the coverage ranges of the beam footprints of the one or more first beams are within the service area. Correspondingly, the content data of the first MBS may be transmitted by using the first beam.

In some implementations, the network device configures not to transmit the content data of the first MBS on a beam whose beam footprint coverage exceeds the geographical area. In other words, the network device configures not to transmit the content data of the first MBS on a beam other than the first beam.

In some implementations, if the service area is associated with one or more first beams, the service area information includes information related to the first beam. In other words, a format of the service area information is of beam-level granularity. For example, if the service area is associated with one or more first beams, the service area includes coverage ranges of beam footprints of the one or more first beams, and the network device may transmit the content data of the first MBS only on the first beam but not on other beams. Accordingly, the terminal device may also determine the first beam based on related information of the first beam, and receive the content data of the first MBS on the first beam, but may not receive the content data of the first MBS on the other beams.

In some implementations, if the service area information includes the related information of the first beam, it may be said that the first information is used to indicate a “beam service state”. When receiving the beam service state, the terminal device may adjust its own behavior. For example, when receiving the related information of the first beam, the terminal device may stop attempting to receive the content data of the first MBS on a beam associated with a non-service area, which can also ensure that the terminal device learns a service state of the first beam before entering coverage of the first beam. This reduces unnecessary energy consumption and potential interference.

In some implementations, the related information of the first beam includes an identifier of the first beam and/or physical layer information of the first beam.

In some implementations, the identifier of the first beam may be an ID of the first beam for identifying the first beam.

In some implementations, the identifier of the first beam may be a content identifier of the first beam, identifying a content ID of a first MBS corresponding to the first beam.

In embodiments of the present application, there may be one or more identifiers of the first beam. For example, there are two identifiers of the first beam, namely, the ID and the content identifier.

In some implementations, the physical layer information of the first beam may be understood as a transmission resource and/or power of the first beam.

In embodiments of the present application, the transmission resource is not limited. In some implementations, the transmission resource may include one or more of the following: a time resource, a frequency resource, or a code resource. For example, the transmission resource includes a time resource. The time resource may include a symbol, a slot, a subframe, a frame, and the like. Certainly, in embodiments of the present application, the transmission resource may further include another time resource introduced in a future communications system. For example, the transmission resource includes a frequency resource. The frequency resource may include a subcarrier, a frequency band, a bandwidth, and the like. Certainly, in embodiments of the present application, the frequency resource may further include another frequency resource introduced in a future communications system. For example, the transmission resource includes a code resource. The code resource may include a codebook, a codeword, and the like. Certainly, in embodiments of the present application, the code resource may further include another code resource introduced in a future communications system.

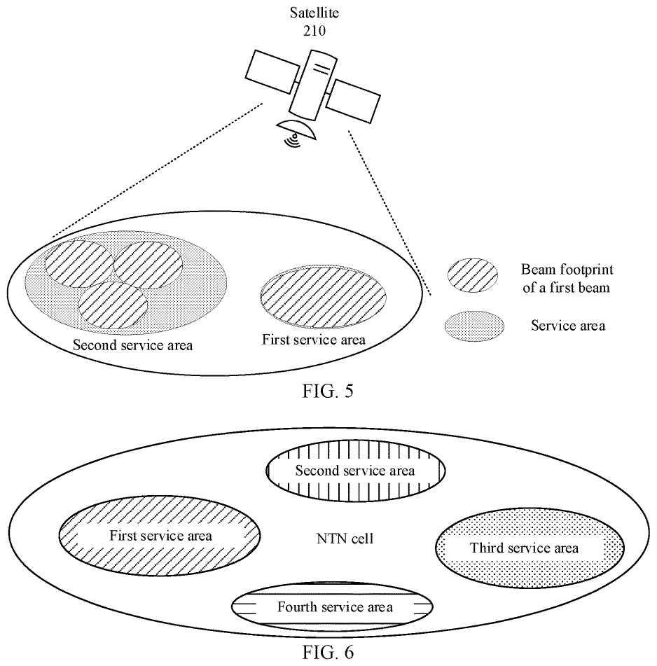

In some implementations, a coverage range of a beam footprint of a first beam associated with the service area may be equal to the service area. For example, referring to FIG. 5, a first service area is associated with one first beam, and a coverage range of a beam footprint of the first beam is equal to the service area.

In some other implementations, the coverage range of the beam footprint of the first beam associated with the service area may be smaller than the service area. For example, referring to FIG. 5, a second service area is associated with three first beams, and coverage ranges of beam footprints of the three first beams are smaller than the second service area.

In some implementations, the first beam is determined based on one or more of the following: an antenna parameter, a service requirement of the terminal device covered by a beam footprint, or a geographical area of the service area.

In some implementations, the antenna parameter may be an array size and/or a phase.

In some implementations, the service requirement of the terminal device covered by the beam footprint may be understood as a service requirement of the terminal device covered by the beam footprint for the first MBS. For example, the service requirement may be whether the terminal device covered by the beam footprint requires the first MBS, that is, whether the terminal device is interested in the first MBS.

In some implementations, the service requirement may be determined based on one or more of the following: distribution of the terminal device covered by the beam footprint; a service requirement of the first MBS; or a quality of service requirement for the first MBS.

In some implementations, the first beam is determined based on the antenna parameter, the service requirement of the terminal device covered by the beam footprint, and the geographical area of the service area. For example, first, a coverage area of each beam on the earth's surface is calculated based on the antenna parameter by using a beamforming technology; second, based on geographic information system (geographic information system, GIS) data, a matching degree between a coverage area of the beam and the geographical area of the service area is determined precisely to identify which beams cover the geographical area of the service area; and finally, which beams among the beams covering the geographical area of the service area are first beams is determined according to the service requirement of the terminal device covered by the beam footprint.

In some implementations, the first beam is determined by a network device. For example, the network device marks which beams belong to the service area, that is, determines first beams associated with the service area, generates related information of the first beams, and transmits the information to the terminal device by using a specific channel.

In some implementations, the service area is determined based on priorities in a list of candidate service areas. For example, a service area having a higher priority in the list of the service areas is selected as a service area corresponding to the first MBS.

In some implementations, the list of the candidate service areas is used to indicate one or more candidate service areas, that is, the list of the candidate service areas is used to indicate one or more alternative service areas.

In some implementations, the list of the candidate service areas is determined based on one or more of the following: distribution of target terminal devices; a service requirement of the first MBS; geographical location information of the NTN cell; or impact of a geographical location of the NTN cell on signal propagation.

In some implementations, the target terminal devices are terminal devices that require the first MBS, that is, the target terminal devices are terminal devices that are interested in the first MBS.

In some implementations, the distribution of the target terminal devices may be understood as distribution of target users of the first MBS.

In some implementations, the list of the candidate service areas is determined based on the distribution of the target terminal devices, which may be understood as that areas requiring the first MBS are determined based on the distribution of the target users. For example, the distribution of the target users may be analyzed based on user positioning data (for example, historical connection records and real-time positioning information) to identify main user gathering areas, thereby determining the areas requiring the first MBS. These areas should cover areas where most of the target users are located.

In some implementations, the list of the candidate service areas is determined based on the service requirement for the first MBS, which may be understood as that a coverage requirement for the service area is determined based on the service requirement for the first MBS. For example, if a service of the first MBS is a large-scale event, public safety broadcasting, or emergency broadcasting, a service area with a larger range is required. However, a service of the first MBS (for example, live broadcast) for a specific user group may require only a service area with a relatively small range.

In some implementations, the list of the candidate service areas is determined based on the geographical location information of the NTN cell and the impact of the geographical location of the NTN cell on signal propagation. For example, if the geographical location of the NTN cell is a plain area with few obstructions, the impact on signal propagation is relatively small, and the coverage range of the service area may be a relatively large area; if the geographical location of the NTN cell is a mountainous area or a densely built-up area, the impact on signal propagation is relatively great, and the coverage range of the service area may be a plurality of relatively small areas.

In some implementations, the priorities in the list of the candidate service areas are determined based on one or more of the following: density of the target terminal devices; a network load; or a coverage effect of the candidate service area. For example, a priority of each candidate service area in the list of the candidate service areas may be sorted based on density of target terminal devices in the candidate service area, a network load of the candidate service area, and a coverage effect of the candidate service area; and priorities of different service areas may be determined based on a sorting result for selecting a final service area from the list of the candidate service areas.

In order for the terminal device to determine a service area of the first MBS of interest, it is necessary to establish an association between the service area and a session of the first MBS. In some implementations, the first association relationship is used to indicate an association relationship between the service area and a session of the first MBS. For example, the session of the first MBS is identified by a session ID and provided in a plurality of service areas; the first association relationship indicates that the service area is associated with the session ID of the first MBS; and the terminal device may determine the session ID of the first MBS corresponding to the service area based on the service area information and the first association relationship.

In some implementations, the first association relationship is used to indicate that one session of the first MBS is associated with one or more service areas.

In some implementations, the first association relationship indicates that one session ID of the first MBS is associated with one or more geographical area IDs of the service area. In this case, the first association relationship provides a finer area granularity for the session of the first MBS, so that the terminal device identifies an available first MBS at a current location of the terminal device, and a geographical area of a first MBS of interest in a currently camped cell.

In some implementations, the service area is associated with one or more first beams; and the first association relationship indicates an association relationship between the first beam and the first MBS. For example, the first association relationship indicates that one session ID of the first MBS is associated with one or more first beam IDs.

In some implementations, a session of the first MBS is associated with one or more pieces of content of the first MBS; and the first association relationship is used to indicate an association relationship between the service area and the content of the first MBS. In other words, different pieces of content of a same session of the first MBS may be distributed in different service areas. Accordingly, when the terminal device moves to a new service area, content data of the first MBS from the new service area should be delivered to the terminal device, and the network device stops delivering, to the terminal device, the content data of the first MBS from the old service area.

In some scenarios, terminal devices in different areas may be interested in a same session of the first MBS (for example, a specific television program). Although content to be transmitted is the same, it is necessary to manage the sessions to be transmitted to these different areas separately. Due to differences in coverage and interference situations of geographical areas, especially in the case of a GEO satellite whose coverage range may be very large, for example, spanning more than 200 kilometers, it is hard to imagine that there is such a large service area that requires the first MBS. Therefore, it may be necessary to divide the session of the first MBS into a plurality of area sessions, to better adapt to conditions of each area.

In some implementations, the session of the first MBS is associated with one or more area sessions. For example, the session ID of the first MBS is associated with a plurality of different area session IDs (Session_ID). The area session IDs are combined with the session ID of the first MBS to uniquely identify a specific portion of a service area for the content data of the first MBS in a 5G system (5G system, 5GS).

The NTN cell may provide, for the session of the first MBS, a service of multiple area sessions (for example, in part of an NTN area), that is, simultaneously transmitting sessions with same content data to a plurality of users in a specific area. In some implementations, one area session ID is associated with one content ID of the first MBS. In other words, one area session is used for transmitting content data corresponding to one content ID. This data transmission mode is generally used for broadcasting content, such as a video stream, an emergency alert, or the like.

For a location-related first MBS, a plurality of pieces of content corresponding to a same session ID of the first MBS may be distributed in each sub-area. An area session ID may identify each distinguishable piece of content that belongs to the session of the first MBS. In some implementations, one session ID of the first MBS corresponds to one or more content IDs. In other words, the network device may divide one session ID of the first MBS into a plurality of content IDs for transmission over different area session IDs.

The network device supports distribution of service area information of a location-related first MBS, while the terminal device learns only the session ID of the first MBS (that is, it is unnecessary for the terminal device to learn the area session ID). It is necessary for the network device to learn the area session ID, the content ID, and the session ID of the first MBS. In some implementations, for different content IDs of the first MBS, the network device may obtain corresponding area session IDs, content IDs, and related area ranges.

In the foregoing case, the terminal device should also be able to learn related information of the content IDs of the first MBS, so that corresponding service area information may be obtained by applying the related information. One service area may have one or more geographical area IDs. Therefore, in some implementations, the first association relationship may be used to indicate one or more of the following: one geographical area ID of the service area being associated with one content ID of the first MBS; a plurality of geographical area IDs of the service area being associated with one content ID of the first MBS; or one geographical area ID of the service area being associated with a plurality of content IDs of the first MBS.

In some implementations, the plurality of geographical area IDs of the service area may be understood as a plurality of geographical area IDs of one or more service areas of the first MBS in the NTN cell. For example, the plurality of geographical area IDs are a plurality of geographical area IDs of one service area. For another example, the plurality of geographical area IDs are a plurality of geographical area IDs of a plurality of service areas, where one service area may correspond to one or more geographical area IDs.

In some implementations, the plurality of content IDs of the first MBS may be understood as a plurality of content IDs corresponding to one or more session IDs of the first MBS. For example, the plurality of content IDs are a plurality of content IDs corresponding to one session ID. For another example, the plurality of content IDs are a plurality of content IDs corresponding to a plurality of session IDs, where one session ID may correspond to one or more content IDs.

When one session of the first MBS is to be transmitted in a wide area, to ensure that terminal devices in different areas can receive signals, it may be necessary to initiate the sessions in different areas separately. Particularly, in a multi-beam scenario, each area covered by a beam may be regarded as a sub-area. In some implementations, the first association relationship indicates that one geographical area ID of the service area is associated with one content ID of the first MBS. For example, referring to FIG. 6, the NTN cell includes four service areas, namely, a first service area, a second service area, a third service area, and a fourth service area. Each of the four service areas corresponds to one geographical area ID; and the geographical area ID of one service area is associated with one content ID of the first MBS. Therefore, content data corresponding to four different content IDs of the first MBS may be transmitted in the four service areas, respectively.

In some implementations, if the first association relationship indicates that one geographical area ID of the service area is associated with a plurality of content IDs of the first MBS, the terminal device may perform handover or cell reselection based on one or more of the following: the geographical area ID; the content IDs; a distance; and a service time. For example, the plurality of content IDs of the first MBS have a specific order, for example, 1, 2, 3, . . . , and N. When performing handover or cell reselection, the terminal device side may perform handover or cell reselection based on the distance and the service time, or based on order of the geographical area IDs and/or order of the content IDs, or based on the distance and the service time in combination with the geographical area IDs and/or the content IDs.

In some implementations, the first information is further used to indicate first indication information, and the first indication information is used to indicate an update to the service area information.

In some implementations, the first indication information is determined based on one or both of the following: a service requirement of the first MBS; or distribution of the target terminal devices. For example, in a broadcast process of the first MBS, target terminal devices in a corresponding service area may change, or a service coverage area of the first MBS may change. In this case, it is necessary to adjust a service area corresponding to the first MBS (for example, adjust beam coverage and broadcast ranges), that is, update the service area information indicated in the first information. In this case, the first information may carry the first indication information. Accordingly, after receiving the first information and obtaining the first indication information, the terminal device may update service area information stored therein to updated service area information indicated by the current first information.

In some implementations, the first information is further used to indicate a frequency selection area identity (frequency selection area identity, FSAI) corresponding to the session ID of the first MBS.

In some implementations, the first information is further used to indicate related information of the first MBS. For example, the first information indicates service information of the first MBS and related information of the session of the first MBS.

In some implementations, the first information is carried in a system information block (system information block, SIB) and/or an MBS broadcast configuration. For example, the first information is carried in a SIB 20 and/or a SIB 21. For another example, the first information is carried in an MCCH composed of MBS broadcast configuration information elements (information elements, IEs).

In some implementations, the first information is carried in a SIB 20. For example, the channel configuration information carried in the SIB 20 is information required for obtaining an MCCH/MTCH configuration for the first MBS broadcast service. For another example, the SIB 20 carries a first association relationship. The first association relationship may be one or more of the association relationships described above, for example, the association relationship between the first beam and the first MBS. The information is related to service continuity of broadcast reception of the first MBS. For another example, the SIB 20 carries service area information, for example, an ID and physical layer information of a first beam, so that the terminal device may learn which frequency or beam is providing the service of the first MBS.

In some implementations, the first information is carried in a SIB 21. For example, the SIB 21 includes an FSAI associated with the session ID of the first MBS. The session ID of the first MBS is configured using upper layer signalling from the network device.

In some implementations, the first information is carried in an MCCH. For example, the MCCH carries a list of all first MBSs having ongoing sessions transmitted on an MTCH and related information of the sessions of the first MBSs, for example, session IDs of the first MBSs, related group radio network temporary identity (group radio network temporary identity, G-RNTI) scheduling information, and the like. The MCCH may further carry channel configuration information. For example, the MCCH may provide MCCH scheduling information for a session of each first MBS, that is, provide MCCH scheduling messages of all different associated service areas for a session of each location-related first MBS. For another example, the service area information may be carried in an MBSBroadcastConfiguration message configuration transmitted on the MCCH; or the service area information may be included in an MBSBroadcastConfiguration message; or the service area information may be embedded in an MBS broadcast configuration IE transmitted on the MCCH. For another example, the first association relationship indicates an association relationship between a geographical area ID and a session ID of the first MBS; and the first association relationship may be carried in an MBSBroadcastConfiguration message transmitted on the MCCH, where a plurality of geographical area IDs may be associated with one or more session IDs of the first MBS.

In some implementations, the first information may also be carried in a SIB 25. For example, the SIB 25 carries geographical area information, for example, coordinates of a reference location and an area radius. The geographical area information is carried in a CoverageAreaInfo IE. In other words, the CoverageAreaInfo IE may indicate a geographical area of the service area of the first MBS.

In some implementations, the first indication information indicated in the first information is carried in a SIB; and the SIB may be periodically broadcast over a control channel. For example, the SIB carrying the first indication information is periodically broadcast over a physical downlink control channel (physical downlink control channel, PDCCH).

In some other implementations, the first indication information indicated in the first information is unicasted to a specific terminal device over a dedicated channel.

As described above, the service area may be associated with one or more first beams. In a case that a coverage range of a beam footprint of a first beam associated with the service area may be smaller than the service area, terminal devices currently located in the service area may be unable to receive the content data of the first MBS. These terminal devices may be terminal devices not covered by the beam footprint of the first beam. There may be questions about how these terminal devices behave. In some implementations, if a terminal device cannot receive the content data of the first MBS in the service area, it may be unnecessary for the terminal device to perform special processing. In some other implementations, the terminal device may perform beam reselection.

In some implementations, if a first condition is met, the terminal device performs beam reselection based on the first information, where the first condition includes one or both of the following: a second beam currently paired with the terminal device being not associated with the first MBS; or the second beam being associated with the first MBS, but the terminal device having not received content data of the first MBS. The terminal device reselects a beam based on the first information, which is conducive to reducing a probability of transmission failure, thereby achieving optimal quality of service.

In some implementations, the second beam is not associated with the first MBS, which may be understood as that the second beam does not support the first MBS.

In some implementations, the second beam is associated with the first MBS, which may be understood as that the second beam supports the first MBS.

In some implementations, whether the second beam is associated with the first MBS is determined based on the first information. For example, the first information indicates first association information; the first association information indicates that one or more first beams are associated with one session of the first MBS; and if the one or more first beams do not include the second beam, it may be determined that the second beam is not associated with the first MBS. For another example, the first information indicates first association information; the first association information indicates that one or more first beams are associated with one session of the first MBS; and if the one or more first beams include the second beam, it may be determined that the second beam is associated with the first MBS.

In some other implementations, whether the second beam is associated with the first MBS is determined based on beam information corresponding to the second beam. For example, if the second beam carries the beam information corresponding thereto, and the beam information does not indicate a session of the first MBS, it may be determined that the second beam is not associated with the first MBS. For another example, if the second beam carries the beam information corresponding thereto, and the beam information indicates a session of the first MBS, it may be determined that the second beam is associated with the first MBS.

In some implementations, the terminal device performs beam reselection based on the first information, which may be understood as that the terminal device determines, based on a predicted beam intensity and the first information, a third beam to be reselected by the terminal device, where the predicted beam intensity is used to indicate a beam intensity predicted for a future instant. The terminal device may use the third beam as a receive beam of the first MBS, which is conducive to improving a success rate of the terminal device in receiving the first MBS, thereby improving service continuity.

In some implementations, the predicted beam intensity may be determined based on a measured beam intensity measured by the terminal device. For example, the terminal device periodically re-evaluates whether transmit-end beams of a network device side are suitable. Specifically, the network device performs beam sweeping; and the terminal device side performs beam measurement to obtain a measured beam intensity corresponding to each beam.

In some implementations, the measured beam intensity may be one or more of the following: layer 1 reference signal received power (layer 1 reference signal received power, L1-RSRP); reference signal received quality (reference signal received quality, RSRQ); received signal strength indication (received signal strength indication, RSSI); or a signal-to-interference-plus-noise ratio (signal interference noise ratio, SINR).

In embodiments of the present application, the predicted beam intensity may be determined by the terminal device, or may be determined by the network device. For example, the terminal device determines predicted beam results of M beams at a future instant t based on M measured beam intensities that are obtained through measurement. For another example, the terminal device reports the M measured beam intensities that are obtained through measurement to the network device; and the network device determines the predicted beam results of the M beams at the future instant t based on the M measured beam intensities.

In some implementations, the measured beam intensity may be determined based on an intensity of the strongest beam that is obtained through measurement and differences between intensities of remaining beams and the intensity of the strongest beam. For example, the measured beam intensity is L1-RSRP; the network device instructs the terminal device to report measured reference signals or beams and an L1-RSRP value of the strongest beam, and for measurement of the remaining M-1 beams, report differences between intensities of the remaining M-1 beams and the L1-RSRP value of the strongest beam; and the network device may determine L1-RSRP values of the remaining M-1 beams based on the L1-RSRP value of the strongest beam and the differences respectively corresponding to the remaining M-1 beams.

In some implementations, the predicted beam intensity includes predicted beam intensities of a plurality of beams, and the predicted beam intensity of the i^{th} beam at an instant t is determined according to a formula PBIᵢ(t)=WBIᵢ(k)+N*[WBIᵢ(k)−WBIᵢ(k-1)], where WBIᵢ(k) denotes a measured beam intensity of the i^{th} beam at an instant k, WBIᵢ(k-1) denotes a measured beam intensity of the i^{th} beam at an instant k-1, N denotes a time interval between the instant t and the instant k, and WBIᵢ(k) and WBIᵢ(k-1) denote measured beam intensities of the i^{th} beam at two instants closest to the instant t.

For ease of obtaining the predicted beam intensity, in some implementations, the terminal device and/or the network device may store the measured beam intensity. For example, the terminal device is provided with a memory, storing measured beam intensities at the two closest instants.

In some implementations, WBIᵢ(k) and WBIᵢ(k-1) denoting the measured beam intensities of the i^{th} beam at the two instants closest to the instant t may be understood as the instant k and the instant k-1 being the two instants closest to the instant t among all instants stored in the terminal device and/or the network device, where the instant k is closest to the instant t, the instant k-1 is an instant before the instant k, and the instant k is before the instant k-1 and the instant t.

In some implementations, the measured beam intensity is L1-RSRP; the predicted beam intensity of the i^{th} beam at the instant t is determined according to a formula RSRPᵢ(t)=RSRPᵢ(k)+N*[RSRPᵢ(k)-RSRPᵢ(k-1)], where RSRPᵢ(k) denotes an L1-RSRP value of the i^{th} beam at the instant k, RSRPᵢ(k-1) denotes an L1-RSRP value of the i^{th} beam at the instant k-1, N denotes a time interval between the instant t and the instant k, and RSRPᵢ(k) and RSRPᵢ(k-1) denote L1-RSRP values of the i^{th} beam at the two instants closest to the instant t. For example, the terminal device reports, on a determined receive beam, an L1-RSRP value of the strongest beam at the instant k and differences between intensities of the remaining M-1 beams and the L1-RSRP value of the strongest beam; the network device is provided with a memory, storing the intensities of the M beams at the instant k reported by the terminal device as RSRPᵢ, i=0,1,2. . . M-1; and the memory may store measured beam intensities at a plurality of instants, but only RSRP values of the M beams at the closest instant k and k-1 are used. The measured beam intensities of the i^{th} beam at the instant k and the instant k-1 may be denoted as RSRPᵢ(k) and RSRPᵢ(k-1) respectively, replacing WBIᵢ(k) and WBIᵢ(k-1) in the above formula. In this case, the predicted beam intensity of the i^{th} beam at the instant t may be determined according to the formula RSRPᵢ(t)=RSRPᵢ(k)+N*[RSRPᵢ(k)-RSRPᵢ(k-1)], so that predicted L1-RSRP values of the M beams at the instant t may be obtained.

In some other implementations, the predicted beam intensity may be predicted by the terminal device or network device by using an artificial intelligence/machine learning (artificial intelligence/machine learning, AI/ML) model; and the measured beam intensity is an input to the AI/ML model. For example, the network device determining the predicted beam intensity by using the AI/ML model is used as an example. The network device side collects enough measured beam intensities for model training. When the model converges and prediction performance indicators meet a requirement, the model enters a model inference phase. In this case, the network device side may perform channel state information (channel state information, CSI) resource and report configuration by using a set B as a measurement set; and the network device performs sweeping over beams in the set B based on the resource configuration. The terminal device performs measurement on a current resource set, and reports measured beam intensities to the network device. The network device uses, as an input to the AI/ML model, the measured beam intensities fed back by the terminal device; and a trained model performs inference based on the input, and outputs predicted beam intensities corresponding to the beams in the set B.

In some implementations, the predicted beam intensity includes predicted beam intensities of a plurality of beams; the service area indicated in the first information is associated with one or more first beams; and in a case that the plurality of beams include the one or more first beams, a first beam with the greatest predicted beam intensity among the one or more first beams is the third beam. For example, the measured beam intensity is L1-RSRP; the measured beam intensity includes predicted beam intensities of the M beams; [RSRPᵢ(t)]_{i=0,1 . . . M-1} is used to denote a sequence of predicted RSRP values of the M beams at the instant t; values in the sequence are sorted; and a beam with the greatest RSRP value at the instant t is selected, that is, a beam corresponding to max|RSRPᵢ(t)| is solved. If the beam is not the first beam (for example, an ID of the beam is not associated with the session of the first MBS), a beam with the second greatest value in the value sequence is selected, whether the selected beam is the first beam is determined, and so on, until the third beam is selected.

In embodiments of the present application, the third beam may also be determined on the network device side. For example, the network device predicts that a beam on which the terminal device receives the first MBS at the instant t may be the third beam. Therefore, a beam on which the first MBS is transmitted may be adjusted to the third beam, thereby improving resource utilization.

As described above, there is an association between the service area and the session of the first MBS, and one service area may include one or more geographical areas. Therefore, it may be necessary to manage and transmit even a same session of the first MBS separately in different geographical areas.

In some implementations, if the first association relationship indicates that a session of the first MBS is associated with one or more geographical areas of the service area, a transmission mode of content data corresponding to the session of the first MBS is determined based on one or more of the following: one or more session IDs of the first MBS; one or more geographical area IDs of the service area; one or more first beam IDs associated with the service area; or one or more transmission time offsets.

In some implementations, the transmission mode of the content data corresponding to the session of the first MBS includes one or more of the following: content data corresponding to one of the session IDs of the first MBS is transmitted in an area corresponding to one of the geographical area IDs; content data corresponding to one of the session IDs of the first MBS is transmitted in areas corresponding to part of the geographical area IDs; content data corresponding to one of the session IDs of the first MBS is simultaneously transmitted in areas corresponding to all of the geographical area IDs; each of the geographical area IDs corresponds to one of the transmission time offsets, and content data corresponding to one of the session IDs of the first MBS is transmitted in areas corresponding to all of the geographical area IDs based on the transmission time offset; or each of the first beam IDs corresponds to one of the geographical area IDs, each of the first beam IDs corresponds to one of the transmission time offsets, and content data corresponding to one of the session IDs of the first MBS is transmitted on a first beam corresponding to one or more of the first beam IDs based on the transmission time offset.

In some implementations, the transmission mode of the content data corresponding to the session of the first MBS is determined based on the session ID of the first MBS and the geographical area ID of the service area, which may be understood as follows: the transmission mode of the content data corresponding to the session of the first MBS includes that content data corresponding to one of the session IDs of the first MBS is transmitted in an area corresponding to one of the geographical area IDs, that is, content data corresponding to different sessions of the first MBS is transmitted in areas corresponding to different geographical area IDs. For example, referring to FIG. 6, there are four service areas in the NTN cell, namely, a first service area, a second service area, a third service area, and a fourth service area. Each service area includes one geographical area ID, so that the NTN cell corresponds to four geographical area IDs. Content data corresponding to different session IDs of the first MBS may be transmitted in areas corresponding to different geographical area IDs, that is, content data corresponding to one of the sessions of the first MBS may be transmitted in an area corresponding to one of the geographical area IDs.

In some implementations, the transmission mode of the content data corresponding to the session of the first MBS is determined based on the session ID of the first MBS and the geographical area ID of the service area, which may be understood as follows: the transmission mode of the content data corresponding to the session of the first MBS includes that content data corresponding to one of the session IDs of the first MBS is transmitted in areas corresponding to part of geographical area IDs of one service area. For example, one service area includes three geographical area IDs; and content data corresponding to one of the session IDs of the first MBS is transmitted in an area corresponding to one of the geographical area IDs. For another example, the first MBS is for an ETWS; and it is necessary for a terminal device in a coverage range of the first MBS to determine, after receiving the content data of the first MBS, whether an emergency action is to be taken. If a satellite coverage range is composed of one or more NTN cells, and an area covered by each NTN cell is very large, an ETWS in an NTN network can be associated only with some geographical areas, that is, content data corresponding to one session ID of the ETWS can be transmitted only in areas corresponding to some geographical area IDs of the NTN cell.

In some implementations, the foregoing part of the geographical area IDs may be specified. For example, a SIB 6 carries this part of the geographical area IDs specified by the network device.

In some implementations, the foregoing part of the geographical area IDs may be determined based on an ID of a first beam. For example, one service area is associated with five first beams; and part of geographical area IDs included in the service area may be determined based on IDs of three of the first beams.

In some implementations, the transmission mode of the content data corresponding to the session of the first MBS is determined based on the session ID of the first MBS and the geographical area ID of the service area, which may be understood as follows: the transmission mode of the content data corresponding to the session of the first MBS includes that content data corresponding to one of the session IDs of the first MBS is simultaneously transmitted in areas corresponding to all of the geographical area IDs. For example, the first association relationship indicates that the session ID of the first MBS is associated with all the geographical area IDs of the service area. In this case, content data corresponding to one of the session IDs of the first MBS may be simultaneously transmitted in the areas corresponding to all of the geographical area IDs.

In some implementations, the transmission mode of the content data corresponding to the session of the first MBS is determined based on the session ID of the first MBS, the geographical area ID of the service area, and the transmission time offset, which may be understood as follows: the transmission mode of the content data corresponding to the session of the first MBS includes that each of the geographical area IDs corresponds to one of the transmission time offsets, and content data corresponding to one of the session IDs of the first MBS is transmitted in areas corresponding to all of the geographical area IDs based on the transmission time offset.

In some implementations, the transmission time offset corresponding to the geographical area ID is determined based on a size of the geographical area ID. For example, a greater geographical area ID indicates a greater transmission time offset corresponding to the geographical area ID; or a greater geographical area ID indicates a smaller transmission time offset corresponding to the geographical area ID. For another example, a random factor is added to a geographical area ID as a transmission time offset corresponding to the geographical area ID.

In some implementations, the transmission mode of the content data corresponding to the session of the first MBS is determined based on the session ID of the first MBS, the geographical area ID of the service area, the first beam ID, and the transmission time offset, which may be understood as follows: the transmission mode of the content data corresponding to the session of the first MBS includes that each of the first beam IDs corresponds to one of the geographical area IDs, each of the first beam IDs corresponds to one of the transmission time offsets, and content data corresponding to one of the session IDs of the first MBS is transmitted on a first beam corresponding to one or more of the first beam IDs based on the transmission time offset.

In some implementations, the transmission mode of the content data corresponding to the session of the first MBS is determined based on the session ID of the first MBS, the geographical area ID of the service area, the first beam ID, and the transmission time offset. The transmission mode of the content data corresponding to the session of the first MBS includes: each of the first beam IDs corresponds to one of the geographical area IDs, each of the first beam IDs corresponds to one of the transmission time offsets, and content data corresponding to one of the session IDs of the first MBS is transmitted on a first beam corresponding to one or more of the beam IDs based on the transmission time offset; or content data corresponding to one of the session IDs of the first MBS is transmitted in an area corresponding to one of the geographical area IDs. For example, each of the first beam IDs corresponds to one of the geographical area IDs; a random number is added to each first beam ID as a transmission time offset corresponding to the first beam ID; and time at which the content data corresponding to the session ID of the first MBS is transmitted on a first beam corresponding to a plurality of first beam IDs corresponding to part of the geographical area IDs may be determined based on the transmission time offset.

As described above, there may be a plurality of service areas within a coverage range of an NTN cell. For example, the coverage range of the NTN cell may overlap with two areas; and the first MBS may intend to cover one of the two areas. The session ID of the first MBS may be associated with a plurality of service areas, and vice versa. A session ID of a first MBS associated with the first MBS service may be provided in an MBSBroadcastConfiguration message. It may rely on the network device to indicate whether only a terminal device located in the service area is allowed to receive the content data of the first MBS.

In some implementations, at a first occasion, the terminal device establishes or releases an MRB associated with the session of the first MBS. In other words, if the network device indicates that the session of the first MBS is allowed to be obtained only in the service area, a terminal device interested in the session of the first MBS may establish or release, at the first occasion, the MRB associated with the session of the first MBS.

In some implementations, the first occasion may include one or more of the following: an occasion at which the session of the first MBS starts; an occasion at which the terminal device enters a service area of the first MBS in which the terminal device is interested, and at which the terminal device is interested in an ongoing broadcast service of the first MBS; an occasion at which a capability restriction of the terminal device that inhibits the terminal device from receiving the ongoing broadcast service of the first MBS is removed, and at which a broadcast MRB establishment process is being applied; an occasion at which location information of the terminal device is obtained; or an occasion at which the service area is updated.

In some implementations, the location information of the terminal device may be understood as global navigation satellite system (global navigation satellite system, GNSS) information related to a location of the terminal device.

In some implementations, the first occasion includes the occasion at which location information of the terminal device is obtained. For example, based on indication of the network device, when the terminal device is not allowed to receive the session of the first MBS outside the service area, the terminal device determines, while obtaining the location information of the terminal device, whether to establish an MRB or release an established MRB. Specifically, when the terminal device obtains its location information, the terminal device may detect whether it is entering or exiting the service area, and determine, based on whether to enter or exit the service area, to establish or release an MRB associated with a session of a first MBS limited to the service area. If the terminal device detects that it has exited the service area, the terminal device may release an established MRB that is associated with the session of the first MBS limited to the service area, or may not establish any MRB that is associated with the session of the first MBS limited to the service area. If the terminal device has not established any MRB, when detecting that the terminal device enters the service area, the terminal device may establish an MRB that is associated with the session of the first MBS limited to the service area.

In some implementations, if the terminal device may receive content data of the first MBS, and is located within the service area, the terminal device is allowed to establish an MRB.

In some implementations, the terminal device may determine, based on second information, whether to discard an MRB. In other words, the terminal device may determine, based on the second information, whether to delete an MRB connection.

In some implementations, the second information is used to indicate one or more of the following: time elapsed since the terminal device leaves the service area; a distance travelled by the terminal device after leaving the service area; content provided by a service area of an adjacent first MBS; or whether the terminal device is interested in the content provided by the service area of the adjacent first MBS.

In some implementations, the terminal device may determine, after leaving the service area or when at a boundary of the service area, whether to discard the MRB.

In some implementations, a terminal device having an NTN capability determines geographical area information based on first information, to determine whether the terminal device has left or entered the service area, or whether the terminal device is at the boundary of the service area. For example, the first information is used to indicate service area information. The service area information includes the geographical area information that may indicate geographical information or boundary information of the service area. The terminal device may obtain its own location information by using a GNSS or another location information service, thereby determining whether the terminal device has left or entered the service area or whether the terminal device is at the boundary of the service area.

The method embodiments of the present application are described in detail above with reference to FIG. 1 to FIG. 6. Apparatus embodiments of the present application are described in detail below with reference to FIG. 7 to FIG. 9. It should be understood that the description of the method embodiments corresponds to the description of the apparatus embodiments. Therefore, for parts that are not described in detail, reference may be made to the foregoing method embodiments.

FIG. 7 is a schematic diagram of a terminal device according to an embodiment of the present application. The terminal device 700 includes a receiving unit 710.

The receiving unit 710 is configured to receive first information transmitted by a network device, where the first information is used to indicate one or more of the following: service area information, where the service area information is used to indicate a service area of a first multicast and broadcast service MBS in a non-terrestrial network NTN cell; channel configuration information, where the channel configuration information is used to indicate configuration information of a channel that is in the service area and carries the first MBS; or a first association relationship, where the first association relationship is used to indicate an association relationship between the service area and the first MBS.

In some implementations, the service area information includes geographical area information, and the geographical area information includes one or more of the following: a reference location, an area radius, a reference time, or geographical area associated information.

In some implementations, the service area is associated with one or more first beams, the first association relationship indicates an association relationship between the first beam and the first MBS, and the service area information includes one or both of the following: an identifier of the first beam; or physical layer information of the first beam.

In some implementations, the first beam is determined based on one or more of the following: an antenna parameter, a service requirement of the terminal device covered by a beam footprint, or a geographical area of the service area.

In some implementations, the terminal device further includes: a reselection unit, where if a first condition is met, the reselection unit is configured to perform beam reselection based on the first information, where the first condition includes one or both of the following: a second beam currently paired with the terminal device being not associated with the first MBS; or the second beam being associated with the first MBS, but the terminal device having not received content data of the first MBS.

In some implementations, the performing, by the terminal device, beam reselection based on the first information includes: determining, by the terminal device based on a predicted beam intensity and the first information, a third beam to be reselected by the terminal device, where the predicted beam intensity is used to indicate a beam intensity predicted for a future instant.

In some implementations, the determining the third beam based on the predicted beam intensity and the first information includes: the predicted beam intensity including predicted beam intensities of a plurality of beams, the service area indicated in the first information being associated with one or more first beams, and in a case that the plurality of beams include the one or more first beams, a first beam with the greatest predicted beam intensity among the one or more first beams being the third beam.

In some implementations, the predicted beam intensity is determined based on a measured beam intensity measured by the terminal device.

In some implementations, the predicted beam intensity being determined based on the measured beam intensity measured by the terminal device includes: the predicted beam intensity including predicted beam intensities of a plurality of beams, and the predicted beam intensity of the i^{th} beam at an instant t being determined according to a formula PBIᵢ(t)=WBIᵢ(k)+N*[WBIᵢ(k)-WBIᵢ(k-1)], where WBIᵢ(k) denotes a measured beam intensity of the i^{th} beam at an instant k, WBIᵢ(k-1) denotes a measured beam intensity of the i^{th} beam at an instant k-1, N denotes a time interval between the instant t and the instant k, and WBIᵢ(k) and WBIᵢ(k-1) denote measured beam intensities of the i^{th} beam at two instants closest to the instant t.

In some implementations, the service area is determined based on priorities in a list of candidate service areas, and the list of the candidate service areas is determined based on one or more of the following: distribution of target terminal devices, where the target terminal devices are terminal devices that require the first MBS; a service requirement of the first MBS; geographical location information of the NTN cell; or impact of a geographical location of the NTN cell on signal propagation.

In some implementations, the priorities in the list of the candidate service areas are determined based on one or more of the following: density of the target terminal devices, a network load, or a coverage effect of the candidate service area.

In some implementations, the first association relationship indicates that a session of the first MBS is associated with one or more geographical areas of the service area, and a transmission mode of content data corresponding to the session of the first MBS is determined based on one or more of the following: one or more session identities IDs of the first MBS; one or more geographical area IDs of the service area; one or more first beam IDs associated with the service area; or one or more transmission time offsets.

In some implementations, the transmission mode of the content data corresponding to the session of the first MBS includes one or more of the following: content data corresponding to one of the session IDs of the first MBS is transmitted in an area corresponding to one of the geographical area IDs; content data corresponding to one of the session IDs of the first MBS is transmitted in areas corresponding to part of the geographical area IDs; content data corresponding to one of the session IDs of the first MBS is simultaneously transmitted in areas corresponding to all of the geographical area IDs; each of the geographical area IDs corresponds to one of the transmission time offsets, and content data corresponding to one of the session IDs of the first MBS is transmitted in areas corresponding to all of the geographical area IDs based on the transmission time offset; or each of the first beam IDs corresponds to one of the geographical area IDs, each of the first beam IDs corresponds to one of the transmission time offsets, and content data corresponding to one of the session IDs of the first MBS is transmitted on a first beam corresponding to one or more of the first beam IDs based on the transmission time offset.

In some implementations, in a case that the first association relationship is used to indicate an association relationship between the service area and content of the first MBS, the first association relationship indicates one or more of the following: one geographical area ID of the service area being associated with one content ID of the first MBS; a plurality of geographical area IDs of the service area being associated with one content ID of the first MBS; or one geographical area ID of the service area being associated with a plurality of content IDs of the first MBS.

In some implementations, the first information is further used to indicate first indication information, and the first indication information is used to indicate an update to the service area information.

In some implementations, the first indication information is determined based on one or both of the following: a service requirement of the first MBS; or distribution of target terminal devices.

In some implementations, the first information is carried in a system information block SIB and/or an MBS broadcast configuration.

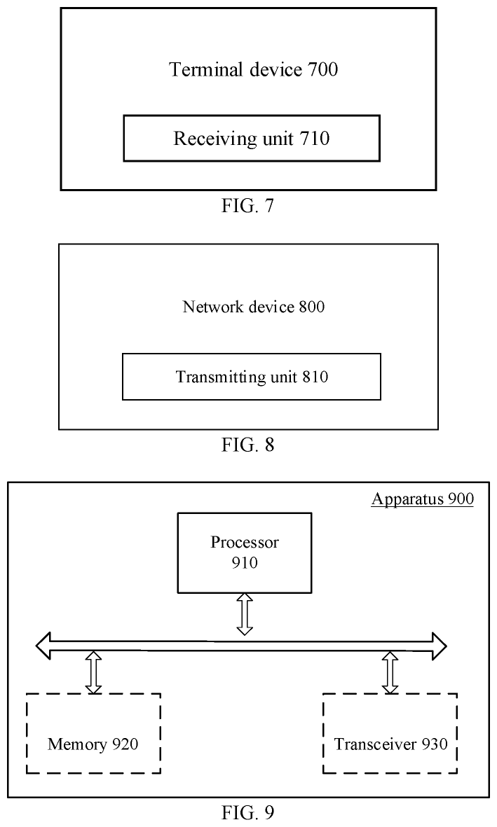

FIG. 8 is a schematic diagram of a network device according to an embodiment of the present application. The network device 800 includes a transmitting unit 810.

The transmitting unit 810 is configured to transmit first information to a terminal device, where the first information is used to indicate one or more of the following: service area information, where the service area information is used to indicate a service area of a first multicast and broadcast service MBS in a non-terrestrial network NTN cell; channel configuration information, where the channel configuration information is used to indicate configuration information of a channel that is in the service area and carries the first MBS; or a first association relationship, where the first association relationship is used to indicate an association relationship between the service area and the first MBS.

In some implementations, the service area information includes geographical area information, and the geographical area information includes one or more of the following: a reference location, an area radius, a reference time, or geographical area associated information.

In some implementations, the service area is associated with one or more first beams, the first association relationship indicates an association relationship between the first beam and the first MBS, and the service area information includes one or both of the following: an identifier of the first beam; or physical layer information of the first beam.

In some implementations, the first beam is determined based on one or more of the following: an antenna parameter, a service requirement of the terminal device covered by a beam footprint, or a geographical area of the service area.

In some implementations, the network device further includes: a determining unit, determining, based on a predicted beam intensity and the first information, a third beam to be reselected by the terminal device, where the predicted beam intensity is used to indicate a beam intensity predicted for a future instant.

In some implementations, the determining the third beam based on the predicted beam intensity and the first information includes: the predicted beam intensity including predicted beam intensities of a plurality of beams, the service area indicated in the first information being associated with one or more first beams, and in a case that the plurality of beams include the one or more first beams, a first beam with the greatest predicted beam intensity among the one or more first beams being the third beam.

In some implementations, the predicted beam intensity is determined based on a measured beam intensity measured by the terminal device.

In some implementations, the predicted beam intensity being determined based on the measured beam intensity measured by the terminal device includes: the predicted beam intensity including predicted beam intensities of a plurality of beams, and the predicted beam intensity of the i^{th} beam at an instant t being determined according to a formula PBIᵢ(t)=WBIᵢ(k)+N*[WBIᵢ(k)-WBIᵢ(k-1)], where WBIᵢ(k) denotes a measured beam intensity of the i^{th} beam at an instant k, WBIᵢ(k-1) denotes a measured beam intensity of the i^{th} beam at an instant k-1, N denotes a time interval between the instant t and the instant k, and WBIᵢ(k) and WBIᵢ(k-1) denote measured beam intensities of the i^{th} beam at two instants closest to the instant t.

In some implementations, the service area is determined based on priorities in a list of candidate service areas, and the list of the candidate service areas is determined based on one or more of the following: distribution of target terminal devices, where the target terminal devices are terminal devices that require the first MBS; a service requirement of the first MBS; geographical location information of the NTN cell; or impact of a geographical location of the NTN cell on signal propagation.

In some implementations, the priorities in the list of the candidate service areas are determined based on one or more of the following: density of the target terminal devices, a network load, or a coverage effect of the candidate service area.

In some implementations, the first association relationship indicates that a session of the first MBS is associated with one or more geographical areas of the service area, and a transmission mode of content data corresponding to the session of the first MBS is determined based on one or more of the following: one or more session identities IDs of the first MBS; one or more geographical area IDs of the service area; one or more first beam IDs associated with the service area; or one or more transmission time offsets.

In some implementations, the transmission mode of the content data corresponding to the session of the first MBS includes one or more of the following: content data corresponding to one of the session IDs of the first MBS is transmitted in an area corresponding to one of the geographical area IDs; content data corresponding to one of the session IDs of the first MBS is transmitted in areas corresponding to part of the geographical area IDs; content data corresponding to one of the session IDs of the first MBS is simultaneously transmitted in areas corresponding to all of the geographical area IDs; each of the geographical area IDs corresponds to one of the transmission time offsets, and content data corresponding to one of the session IDs of the first MBS is transmitted in areas corresponding to all of the geographical area IDs based on the transmission time offset; or each of the first beam IDs corresponds to one of the geographical area IDs, each of the first beam IDs corresponds to one of the transmission time offsets, and content data corresponding to one of the session IDs of the first MBS is transmitted on a first beam corresponding to one or more of the first beam IDs based on the transmission time offset.

In some implementations, in a case that the first association relationship is used to indicate an association relationship between the service area and content of the first MBS, the first association relationship indicates one or more of the following: one geographical area ID of the service area being associated with one content ID of the first MBS; a plurality of geographical area IDs of the service area being associated with one content ID of the first MBS; or one geographical area ID of the service area being associated with a plurality of content IDs of the first MBS.

In some implementations, the first information is further used to indicate first indication information, and the first indication information is used to indicate an update to the service area information.

In some implementations, the first indication information is determined based on one or both of the following: a service requirement of the first MBS; or distribution of target terminal devices.

In some implementations, the first information is carried in a system information block SIB and/or an MBS broadcast configuration.

In an optional embodiment, the receiving unit 710 may be a transceiver 930. The terminal device 700 may further include a processor 910 and a memory 920. Details are shown in FIG. 9.

In an optional embodiment, the transmitting unit 810 may be a transceiver 930. The network device 800 may further include the processor 910 and the memory 920. Details are shown in FIG. 9.

FIG. 9 is a schematic structural diagram of a communications apparatus according to an embodiment of the present application. Dashed lines in FIG. 9 indicate that the units or modules are optional. The apparatus 900 may be configured to implement a method described in the foregoing method embodiments. The apparatus 900 may be a chip, a terminal device, or a network device.

The apparatus 900 may include one or more processors 910. The processor 910 may support the apparatus 900 in implementing a method described in the foregoing method embodiments. The processor 910 may be a general-purpose processor or a dedicated processor. For example, the processor may be a central processing unit (central processing unit, CPU). Alternatively, the processor may be another general-purpose processor, a digital signal processor (digital signal processor, DSP), an application-specific integrated circuit (application specific integrated circuit, ASIC), a field-programmable gate array (field programmable gate array, FPGA) or another programmable logic device, a discrete gate or transistor logic device, a discrete hardware component, or the like. The general-purpose processor may be a microprocessor, or the processor may be any conventional processor or the like.

The apparatus 900 may further include one or more memories 920. The memory 920 stores a program. The program may be executed by the processor 910, to cause the processor 910 to execute a method described in the foregoing method embodiments. The memory 920 may be separate from the processor 910 or may be integrated into the processor 910.

The apparatus 900 may further include a transceiver 930. The processor 910 may communicate with another device or chip by using the transceiver 930. For example, the processor 910 may transmit data to and receive data from another device or chip by using the transceiver 930.

An embodiment of the present application further provides a computer-readable storage medium for storing a program. The computer-readable storage medium may be applied to the terminal or network device provided in embodiments of the present application, and the program causes a computer to execute a method executed by the terminal or network device in various embodiments of the present application.

An embodiment of the present application further provides a computer program product. The computer program product includes a program. The computer program product may be applied to the terminal or network device provided in embodiments of the present application, and the program causes a computer to execute a method executed by the terminal or network device in various embodiments of the present application.

An embodiment of the present application further provides a computer program. The computer program may be applied to the terminal or network device provided in embodiments of the present application, and the computer program causes a computer to execute a method executed by the terminal or network device in various embodiments of the present application.

It should be understood that the terms “system” and “network” in the present application may be used interchangeably. In addition, the terms used in the present application are merely used to explain the specific embodiments of the present application, but are not intended to limit the present application. The terms “first”, “second”, “third”, “fourth”, and the like in the specification, claims, and drawings of the present application are used to distinguish between different objects, rather than to describe a specific order. In addition, the terms “include” and “have” and any variations thereof are intended to cover a non-exclusive inclusion.

In embodiments of the present application, “indicate” mentioned herein may refer to a direct indication, or may refer to an indirect indication, or may mean that there is an association relationship. For example, A indicates B, which may mean that A directly indicates B, for example, B may be obtained by means of A; or may mean that A indirectly indicates B, for example, A indicates C, and B may be obtained by means of C; or may mean that there is an association relationship between A and B.

In embodiments of the present application, the term “correspond” may mean that there is a direct or indirect correspondence between the two, or may mean that there is an association relationship between the two, or may mean that there is a relationship such as indicating and being indicated, or configuring and being configured.

In embodiments of the present application, the “protocol” may refer to a standard protocol in the communications field, and may include, for example, an LTE protocol, an NR protocol, and a related protocol applied to a future communications system, which is not limited in the present application.

In embodiments of the present application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In several embodiments provided in the present application, it should be understood that the disclosed system, apparatus, and method may be implemented in other manners. For example, the described apparatus embodiments are merely examples. For example, unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented by using some interfaces. The indirect couplings or communication connections between the apparatuses or units may be implemented in electrical, mechanical, or other forms.

Units described as separate components may be or may not be physically separate, and components displayed as units may be or may not be physical units, that is, may be located at one location or distributed on a plurality of network units. Part or all of the units may be selected according to actual needs to achieve the objectives of solutions in embodiments.

In addition, functional units in various embodiments of the present application may be integrated into one processing unit, or each of the units may exist alone physically, or two or more units may be integrated into one unit.

All or part of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of the present application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (for example, a coaxial cable, an optical fiber, and a digital subscriber line (digital subscriber line, DSL)) manner or a wireless (for example, infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (digital video disc, DVD)), a semiconductor medium (for example, a solid state disk (solid state disk, SSD)), or the like.

The foregoing descriptions are merely specific implementations of the present application, but the protection scope of the present application is not limited thereto. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A wireless communication method, comprising:
receiving, by a terminal device, first information from a network device, wherein the first information indicates one or more of following:
service area information, wherein the service area information indicates a service area of a first multicast and broadcast service (MBS) in a non-terrestrial network (NTN) cell;
channel configuration information, wherein the channel configuration information indicates configuration information of a channel that is in the service area and carries the first MBS; or
a first association relationship, wherein the first association relationship indicates an association relationship between the service area and the first MBS.

2. The method according to claim 1, wherein the service area information comprises geographical area information, and the geographical area information comprises one or more of following:
a reference location;
an area radius;
a reference time; or
geographical area associated information.

3. The method according to claim 1, wherein the service area is associated with one or more first beams, the first association relationship indicates an association relationship between the first beam and the first MBS, and the service area information comprises one or both of following:
an identifier of the first beam; or
physical layer information of the first beam.

4. The method according to claim 3, wherein the first beam is determined based on one or more of following:
an antenna parameter;
a service requirement of the terminal device covered by a beam footprint; or
a geographical area of the service area.

5. The method according to claim 1, further comprising:
performing, by the terminal device, beam reselection based on the first information in a case that a first condition is met, wherein the first condition comprises one or both of following:
a second beam currently paired with the terminal device being not associated with the first MBS; or
the second beam being associated with the first MBS, but the terminal device having not received content data of the first MBS.

6. The method according to claim 5, wherein the performing, by the terminal device, beam reselection based on the first information comprises:
determining, by the terminal device based on a predicted beam intensity and the first information, a third beam to be reselected by the terminal device, wherein the predicted beam intensity indicates a beam intensity predicted for a future instant.

7. The method according to claim 6, wherein the predicted beam intensity comprises predicted beam intensities of a plurality of beams, the service area indicated in the first information is associated with one or more first beams, and wherein the determining the third beam based on the predicted beam intensity and the first information comprises:
in a case that the plurality of beams comprise the one or more first beams, determining that a first beam with a greatest predicted beam intensity among the one or more first beams is the third beam.

8. The method according to claim 6, wherein the predicted beam intensity is determined based on a measured beam intensity measured by the terminal device.

9. The method according to claim 8, wherein the predicted beam intensity being determined based on the measured beam intensity measured by the terminal device comprises:
the predicted beam intensity comprising predicted beam intensities of a plurality of beams, and the predicted beam intensity of an i^{th} beam at an instant t being determined according to a formula PBIᵢ(t )=WBIᵢ(k)+N*[WBIᵢ(k)-WBIᵢ(k-1)],
wherein WBIᵢ(k) denotes a measured beam intensity of the i^{th} beam at an instant k, WBIᵢ(k-1) denotes a measured beam intensity of the i^{th} beam at an instant k-1, N denotes a time interval between the instant t and the instant k, and WBIᵢ(k) and WBIᵢ(k-1) denote measured beam intensities of the i^{th} beam at two instants closest to the instant t.

10. The method according to claim 1, wherein the service area is determined based on priorities in a list of candidate service areas, and the list of the candidate service areas is determined based on one or more of following:
distribution of target terminal devices, wherein the target terminal devices are terminal devices that require the first MBS;
a service requirement of the first MBS;
geographical location information of the NTN cell; or impact of a geographical location of the NTN cell on signal propagation.

11. The method according to claim 10, wherein the priorities in the list of the candidate service areas are determined based on one or more of following:
density of the target terminal devices;
a network load; or
a coverage effect of the candidate service area.

12. The method according to claim 1, wherein the first association relationship indicates that a session of the first MBS is associated with one or more geographical areas of the service area, and a transmission mode of content data corresponding to the session of the first MBS is determined based on one or more of following:
one or more session identities IDs of the first MBS;
one or more geographical area IDs of the service area;
one or more first beam IDs associated with the service area; or
one or more transmission time offsets.

13. The method according to claim 12, wherein the transmission mode of the content data corresponding to the session of the first MBS comprises one or more of following:
content data corresponding to one of the session IDs of the first MBS is transmitted in an area corresponding to one of the geographical area IDs;
content data corresponding to one of the session IDs of the first MBS is transmitted in areas corresponding to part of the geographical area IDs;
content data corresponding to one of the session IDs of the first MBS is simultaneously transmitted in areas corresponding to all of the geographical area IDs;
each of the geographical area IDs corresponds to one of the transmission time offsets, and content data corresponding to one of the session IDs of the first MBS is transmitted in areas corresponding to all of the geographical area IDs based on the transmission time offset; or
each of the first beam IDs corresponds to one of the geographical area IDs, each of the first beam IDs corresponds to one of the transmission time offsets, and content data corresponding to one of the session IDs of the first MBS is transmitted on a first beam corresponding to one or more of the first beam IDs based on the transmission time offset.

14. The method according to claim 1, wherein in a case that the first association relationship indicates an association relationship between the service area and content of the first MBS, the first association relationship indicates one or more of following:
one geographical area ID of the service area being associated with one content ID of the first MBS;
a plurality of geographical area IDs of the service area being associated with one content ID of the first MBS; or
one geographical area ID of the service area being associated with a plurality of content IDs of the first MBS.

15. The method according to claim 1, wherein the first information further indicates first indication information, and the first indication information indicates an update to the service area information.

16. The method according to claim 15, wherein the first indication information indicates a service requirement of the first MBS.

17. The method according to claim 1, wherein the first information is carried in at least one of a system information block (SIB) or an MBS broadcast configuration.

18. A wireless communication method, comprising:
transmitting, by a network device, first information to a terminal device, wherein the first information indicates one or more of following:
service area information, wherein the service area information indicates a service area of a first multicast and broadcast service (MBS) in a non-terrestrial network (NTN) cell;
channel configuration information, wherein the channel configuration information indicates configuration information of a channel that is in the service area and carries the first MBS; or
a first association relationship, wherein the first association relationship indicates an association relationship between the service area and the first MBS.

19. An apparatus, comprising:
at least one processor; and
one or more non-transitory computer-readable storage media coupled to the at least one processor and storing programming instructions for execution by the at least one processor, wherein the programming instructions, when executed, cause the apparatus to perform operations comprising:
receiving first information from a network device, wherein the first information indicates one or more of following:
service area information, wherein the service area information indicates a service area of a first multicast and broadcast service (MBS) in a non-terrestrial network (NTN) cell;
channel configuration information, wherein the channel configuration information indicates configuration information of a channel that is in the service area and carries the first MBS; or
a first association relationship, wherein the first association relationship indicates an association relationship between the service area and the first MBS.

20. The apparatus according to claim 19, wherein the service area information comprises geographical area information, and the geographical area information comprises one or more of following:
a reference location;
an area radius;
a reference time; or
geographical area associated information.
